(19) United States
(12) Patent Application Publication
(10) Pub. No.: US 2019/0160992 A1
(43) Pub. Date: May 30, 2019

(54) REFRESH DEVICE

(71) Applicant: AISIN SEIKI KABUSHIKI KAISHA, Kariya-shi (JP)

(72) Inventor: Naoya ISHIDA, Chiryu-shi (JP)

(73) Assignee: AISIN SEIKI KABUSHIKI KAISHA, Kariya-shi (JP)

(21) Appl. No.: 16/179,110

(22) Filed: Nov. 2, 2018

(30) Foreign Application Priority Data
Nov. 27, 2017 (JP) 2017-226933

(51) Int. Cl. B60N 2/90; A61H 23/00

(52) U.S. Cl. CPC B60N 2/976; A61H 23/00; A61H 2203/0431; A61H 2201/0149; A61H 2201/5043; B60N 2002/981

(57) ABSTRACT

A refresh device that refreshes an occupant of a vehicle includes: a control device; and a relaxation device controlled by the control device, in which the control device causes the relaxation device to execute a refresh operation that alleviates tension of the occupant based on at least one information of traveling state information of the vehicle, information on a vehicle position and a road around the vehicle position, and information on a traffic control device around the vehicle.

### CROSS REFERENCE TO RELATED APPLICATIONS

This application is based on and claims priority under 35 U.S.C. § 119 to Japanese Patent Application 2017-226933, filed on Nov. 27, 2017, the entire contents of which are incorporated herein by reference.

### TECHNICAL FIELD

This disclosure relates to a refresh device provided in a vehicle seat.

### BACKGROUND DISCUSSION

As a technology related to a refresh device mounted on a vehicle, a technology described in JP 2017-052332A (Reference 1) is known.

A device described in Reference 1 expands and contracts a massage bag provided within a seat, based on a body motion of an occupant such as respiration.

However, according to the above technology, an opportunity that an occupant (including a driver) is automatically subjected to a refresh action is limited to only a case where his body motion is made. In this respect, there is a room for improvement in a conventional refresh device. Thus, a need exists for a relaxation device which is not susceptible to the drawback mentioned above.

### SUMMARY

A refresh device according to an aspect of this disclosure refreshes an occupant of a vehicle, and includes a control device, and a relaxation device controlled by the control device. The control device causes the relaxation device to execute a refresh operation that alleviates tension of the occupant based on at least one information of traveling state information of the vehicle, information on a vehicle position and a road around the vehicle position, and information on a traffic control device around the vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a seat including a refresh device;

FIG. 2 is a block diagram of the refresh device;

FIG. 3 is a schematic view of a relaxation device;

FIG. 4 is a view for explaining a predicted acceleration;

FIG. 5 is a flow chart of an operation controlling process;

FIG. 6 is a flow chart of an operation controlling process during travelling;

FIG. 7 is a view for explaining an operation controlling process in another embodiment; and

FIG. 8 is a flow chart of an operation controlling process in another embodiment.

### DETAILED DESCRIPTION

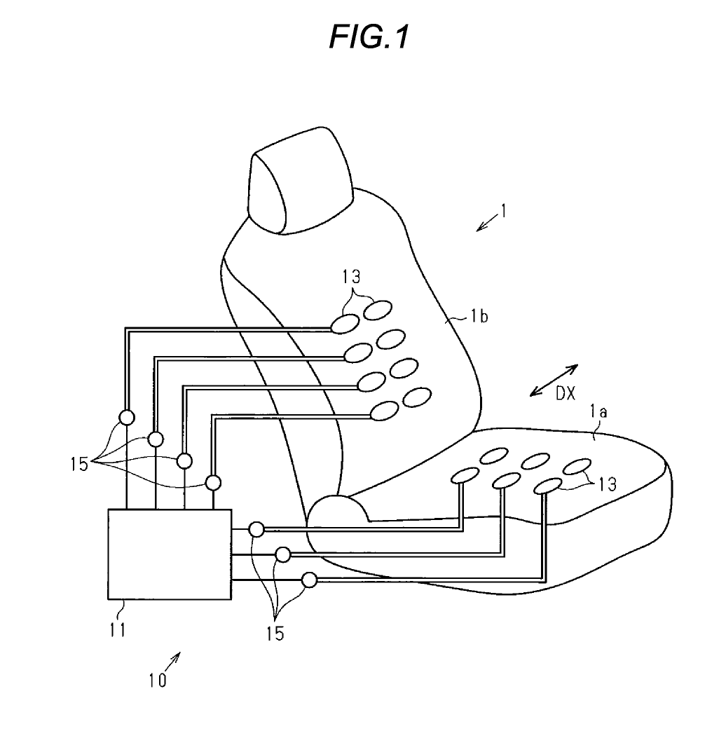

A refresh device will be described with reference to FIGS. 1 to 6.

In the following description, “a vehicle width direction DX” in a seat 1 indicates a direction of a vehicle along a vehicle width direction.

A refresh device 10 is mounted in the vehicle. The refresh device 10 gives an action (an appropriate stimulation) of refreshing an occupant to the corresponding occupant sitting on the seat 1 of the vehicle. For example, the refresh device 10 is provided in the seat 1 for a driver.

As illustrated in FIG. 1, an air bag 13 (see below) of the refresh device 10 is disposed within the seat 1.

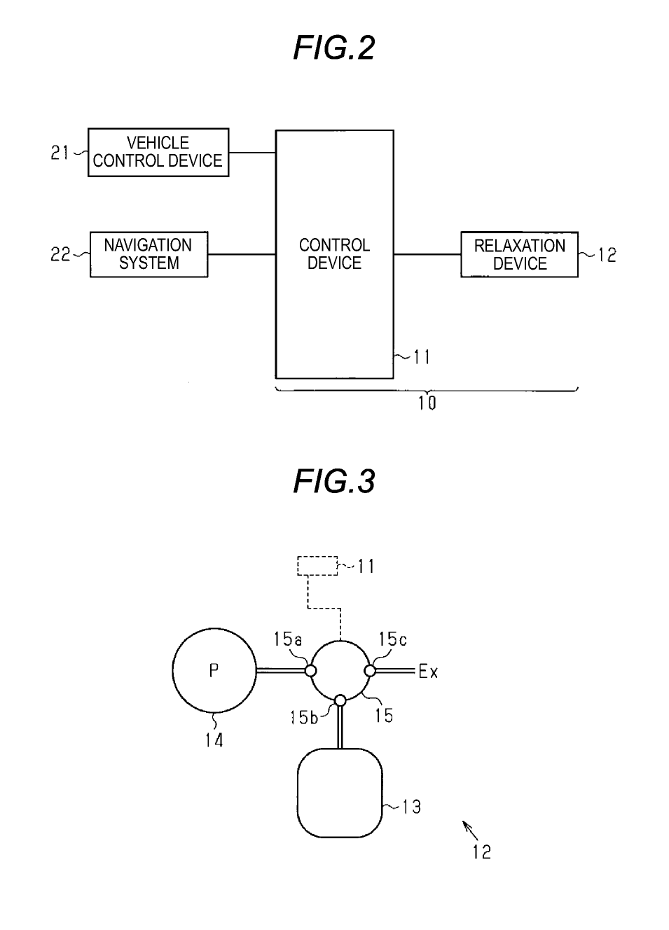

As illustrated in FIG. 2, the refresh device 10 includes a control device 11, and a relaxation device 12 operating by a command of the control device 11.

The relaxation device 12 gives a refresh effect to the occupant sitting on the seat 1. The relaxation device 12 is configured to give vibration to a body. A proper vibration applied to the body exerts a refresh effect on the occupant. A vibration formed by the relaxation device 12 is a vibration with a predetermined cycle or a predetermined pattern, which gives a refresh effect to the occupant, and the vibration intensity is adjusted to an appropriate magnitude that gives the refresh effect to the occupant. The relaxation device 12 is constituted by, for example, a vibrating body vibrating by a motor, a vibrating bag vibrating by supply/discharge of a gas or a liquid, or the like.

An example of the relaxation device 12 will be described with reference to FIG. 3.

The relaxation device 12 includes the air bag 13, a pump 14 that supplies air, and a control valve 15 provided in a flow path connecting the pump 14 to the air bag 13. The control valve 15 is controlled by the control device 11. The control valve 15 is constituted by, for example, a cross valve. The control valve 15 includes a first port 15a connected to the pump 14, a second port 15b connected to the air bag 13, and a third port 15c connected to an exhaust port Ex.

The control device 11 operates the control valve 15 so that supply and exhaust of air to/from the air bag 13 are repeated to vibrate the air bag 13. As described above, the air bag 13 is disposed within the seat 1. For example, in each of a seat cushion 1a and a seat back 1b, the plurality of air bags 13 are disposed. The air bags 13 operate in conjunction with each other, or individually and independently. Operations, such as a vibration mode of the air bag 13, stop of vibration, or start of vibration, are controlled by the control valve 15, as described above.

The control device 11 operates the relaxation device 12 based on at least one information of traveling state information of a vehicle, information on a vehicle position PM and a road around the vehicle position PM, and information on a traffic control device around the vehicle (for example, a traffic light). Accordingly, the relaxation device 12 operates based on at least one information of the traveling state information of the vehicle, the information on the vehicle position PM and the road around the vehicle position PM, and the information on the traffic control device around the vehicle.

The control device 11 acquires the traveling state information from a vehicle control device 21 via an in-vehicle communication network. The vehicle control device 21 is a device mounted in the vehicle, and outputs at least the traveling state information of the vehicle, such as a vehicle speed, a vehicle acceleration, or a brake operating state. As the traveling state information, a vehicle speed V, an acceleration, a brake operating state and the like may be exemplified. In the embodiment disclosed here, the control device 11 acquires a vehicle speed V and a brake operating state at the present point in time.

The control device 11 acquires a vehicle position PM, road information around the vehicle position PM, and a traveling direction of the vehicle on a map, from a navigation system 22 in order to determine a point in time the relaxation device 12 is to be operated. The road information around the vehicle position PM is information on a road in a predetermined range including the vehicle position PM (a position specifiable by a latitude and a longitude). The road information around the vehicle position PM may be, for example, a curvature Ri of a road including the vehicle position PM, information indicating whether the vehicle position PM is present within an intersection area AC, a distance from the center of an intersection to the vehicle position PM in a case where the vehicle position PM is present within the intersection area AC, an inclination angle of a road including the vehicle position PM, and the like.

The navigation system 22 outputs at least the vehicle position PM on the map, the road information around the vehicle position PM, and the traveling direction of the vehicle on the map. The navigation system 22 may have a function of indicating a route to a destination.

The control device 11 preferably acquires information on a traffic control device around the vehicle. The traffic control device is, for example, a traffic light. The information on the traffic control device is, for example, traffic permission information indicated by the traffic light. The traffic permission information includes the following three of information, that is, information of “prohibition to proceed” displayed in red on the traffic light, information of “permission to proceed” displayed in green, and information of “warning” displayed in yellow. The control device 11 obtains information on the traffic control device from, for example, a signal recognition device (not illustrated) mounted in the vehicle, or a transmission device (not illustrated) of the traffic light. The transmission device of the traffic light wirelessly outputs traffic permission information on each lane which is indicated by the traffic light, and position information of the traffic light.

The control device 11 preferably calculates a “predicted acceleration G.” The predicted acceleration G is an acceleration applied to the vehicle in the vehicle width direction DX, and indicates an acceleration at a point in time after a lapse of a set time from the present point in time (hereinafter, a “predicted time point”).

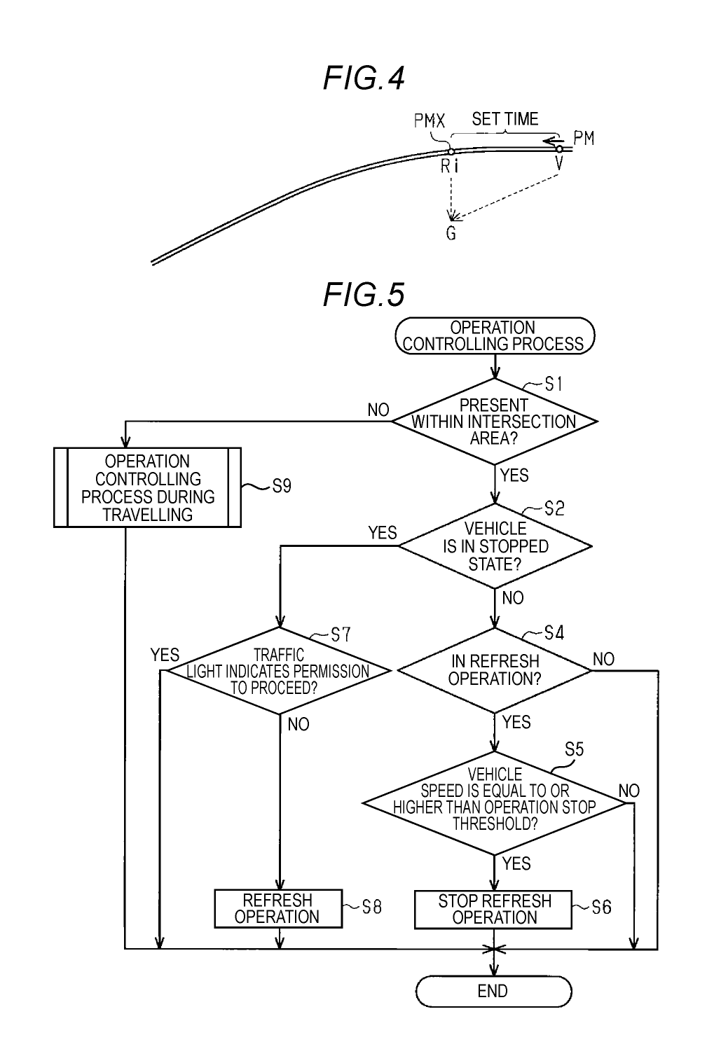

The predicted acceleration G will be described with reference to FIG. 4. The arrow in FIG. 4 indicates a traveling direction of the vehicle. The control device 11 calculates the predicted acceleration G by the following procedures (a) to (c). In the calculation of the predicted acceleration G, it is assumed that a speed at a predicted time point is the same as a speed at the present point in time. (a) The control device 11 acquires a vehicle position PM at the present point in time, road information around the vehicle position PM at the present point in time, and a traveling direction of the vehicle on the map, from the navigation system 22. (b) The control device 11 specifies a vehicle position PMX after a lapse of a set time, based on the vehicle position PM at the present point in time, the traveling direction of the vehicle, a vehicle speed V at the present point in time, and road information of a road where the corresponding vehicle travels. (c) The control device 11 acquires a curvature Ri at the vehicle position PMX after the lapse of the set time, from the navigation system 22. Then, the acceleration at the vehicle position PMX is calculated as the predicted acceleration G based on the curvature Ri at the vehicle position PMX, and the vehicle speed V.

The control device 11 operates the relaxation device 12 such that tension of an occupant is alleviated when predetermined conditions are satisfied. In the embodiment disclosed here, the operation of the relaxation device 12 will be referred to as a “refresh operation.” For example, the control device 11 causes the relaxation device 12 to execute a refresh operation under a condition in which the vehicle is present within the intersection area AC and the vehicle is stopped (see steps S1 and S2 in an “operation controlling process”). The control device 11 causes the relaxation device 12 to execute a refresh operation under a condition in which the vehicle is travelling on a specific road (for example, a road specified in advance, such as a highway) and the forward road is straight (see steps S10 to S12 in an “operation controlling process during travelling”). In the following description, the specific road is specified as a “highway.”

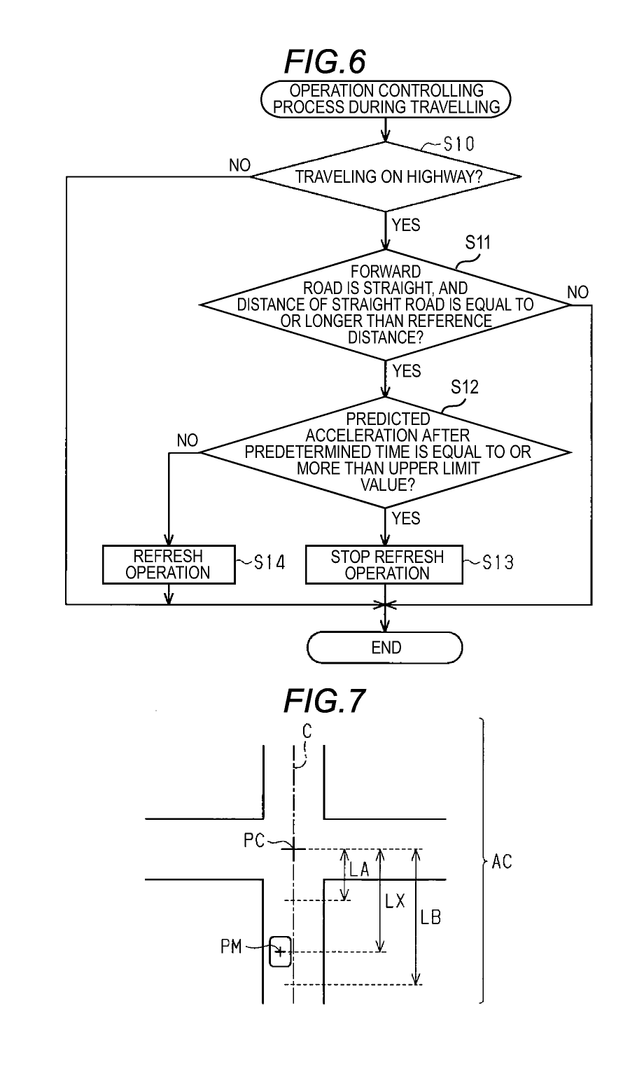

An example of the “operation controlling process” executed by the control device 11 of the refresh device 10 will be described with reference to FIGS. 5 and 6. The control device 11 operates the relaxation device 12 under a predetermined condition by executing the operation controlling process. Specifically, in the operation controlling process, a vehicle speed and a brake operating state, a vehicle position PM, and information indicating whether the vehicle position PM is present within an intersection area AC are used. The intersection area AC is set at the intersection on the map.

The control device 11 periodically executes the “operation controlling process.” In the following description, the phrase “end the operation controlling process” indicates that a series of steps in the “operation controlling process” are completed, and a standby state is made for execution of the following cycle of the “operation controlling process.”

In step S1, the control device 11 determines whether the vehicle is present within the intersection area AC. The control device 11 determines whether the vehicle is present within the intersection area AC, based on whether the vehicle position PM is present within the intersection area AC. When the vehicle is not within the intersection area AC (NO determination), the process proceeds to step S9, and the “operation controlling process during travelling” to be described below will be executed. When the vehicle is present within the intersection area AC (YES determination), processings within the intersection area AC are executed in step S2 and subsequent steps.

In step S2, the control device 11 determines whether the vehicle is in a stopped state. The stopped state is defined as a state in which the vehicle speed V is “0” or close to “0” (for example, 0 km/m or more, Akm/h or less). The stopped state may be defined as a state in which a brake is operating. When it is determined that the vehicle is in the stopped state (YES determination), the control device 11 determines whether a traffic light indicates permission to proceed in step S7. For example, the control device 11 obtains traffic permission information indicating whether the traffic light indicates permission to proceed, from a signal recognition device attached to the vehicle or a transmission device of the traffic light. When the traffic light indicates permission to proceed (YES determination), the operation controlling process temporarily ends. When the traffic light does not indicate permission to proceed (NO determination), the process proceeds to step S8, and the relaxation device 12 is caused to execute the above described “refresh operation.”

When it is determined that the vehicle is not in the stopped state in step S2, the control device 11 determines whether the “refresh operation” is being executed in step S4. When the “refresh operation” is not being executed, the operation controlling process temporarily ends. When the vehicle is present within the intersection area AC, the vehicle is not in the stopped state, and the “refresh operation” is being executed, in step S5, the control device 11 determines whether the vehicle speed V is equal to or higher than an operation stop threshold. When the vehicle speed V is equal to or higher than the operation stop threshold (“YES” in step S5), the control device 11 stops the refresh operation in step S6. When the vehicle speed V is lower than the operation stop threshold (“NO” in step S5), the control device 11 does not stop the refresh operation.

According to the above control, when the vehicle is present within the intersection area AC, the refresh operation is executed under a condition in which the vehicle is in the stopped state. Then, in a case where the vehicle is present within the intersection area AC, during execution of the refresh operation, the refresh operation is stopped under a condition in which the vehicle speed is equal to or higher than the operation stop threshold. Meanwhile, when the vehicle speed is lower than the operation stop threshold (for example, in a case where the vehicle slowly moves at the time of congestion), the refresh operation is continued.

The “operation controlling process during travelling” will be described with reference to FIG. 6.

In step S10, the control device 11 determines whether the vehicle is travelling on a highway. For example, the control device 11 determines whether the vehicle position PM is present on the highway based on information from the navigation system 22. When the vehicle is not travelling on the highway, the control device 11 ends the “operation controlling process during travelling,” and returns to the “operation controlling process.” When the vehicle is traveling on the highway, in step S11, the control device 11 determines whether the forward road is straight, and the distance of the straight road is equal to or longer than a reference length (see below).

In step S11, when it is determined that the forward road is not straight (NO determination), or even in a case where the forward road is straight, when the distance of the straight road is shorter than the reference length, the control device 11 ends the “operation controlling process during travelling.” In step S11, when the control device 11 determines that the forward road is straight and the distance of the straight road is equal to or longer than the reference length (YES determination), the process proceeds to step S12.

In step S12, the control device 11 determines whether a predicted acceleration G after a lapse of a set time is equal to or more than the upper limit value. When determining that the predicted acceleration G is equal to or more than the upper limit value, in step S13, the control device 11 stops the refresh operation in a case where the refresh operation is being executed. When determining that the predicted acceleration G after a lapse of a set time is less than the upper limit value, the control device 11 executes the refresh operation in step S14, or continues the refresh operation in a case where the refresh operation is being executed.

According to the above control, when the straight road in front of the vehicle on the highway continues over a distance equal to or longer than a reference distance, the refresh operation is executed. Then, when the distance of the straight road extending in front of the vehicle is shorter than the reference distance, the refresh operation is stopped.

For example, the control device 11 determines whether the road is straight and whether the straight road is equal to or longer than a reference distance, as follows.

The navigation system 22 stores curvatures Ri at positions at predetermined intervals on each road. For example, curvatures Ri are set every several meters on each road. The control device 11 acquires all curvatures Ri between the vehicle position PM at the present point in time, and a position ahead of the vehicle position PM by the reference distance (hereinafter, “forward position”). Then, when all curvatures Ri set from the vehicle position PM to a predetermined forward position fall within a predetermined range (for example, −A or more and +A or less. “−” indicates bending to the left, and “+” indicates bending to the right), the control device 11 determines that the road is a straight road, and a distance of the straight road is equal to or longer than the reference distance.

The range in the predetermined range (−A or more and +A or less) may be changed based on a vehicle speed. This is because when the vehicle speed is high, even a slight curve may require an attentiveness. For example, the control device 11 narrows the width of the predetermined range according to a magnitude of a vehicle speed at the present point in time. In this manner, it is possible to give a refresh operation to an occupant at a proper time by changing the definition of “straight” according to the vehicle speed.

An action of the refresh device 10 will be described.

According to the above “operation controlling process,” a refresh operation is executed in an intersection area AC and on a highway.

Specifically, when the vehicle is in a stopped state in the intersection area AC, the refresh operation is executed. When the vehicle starts to move in the intersection area AC, the refresh operation continues until the vehicle speed V becomes equal to or higher than an operation stop reference, and the refresh operation is stopped when the vehicle speed V is equal to or higher than the operation stop reference. On the highway, when a straight line distance continues, the refresh operation is executed, and when a curve approaches, the refresh operation is stopped.

As described above, the refresh operation is automatically executed in a status where the necessity of attentiveness of an occupant (for example, a driver) is small. That is, since the occupant is subjected to the refresh operation when the occupant may relax, the refresh effect is increased. The refresh operation is automatically stopped in a status where the attentiveness of the occupant becomes necessary. Since a change, such as the stop of the refresh operation, may be given to the occupant, when the attentiveness is required, it is possible to call the occupant's attentiveness. Since the refresh operation is stopped when an attentiveness to driving is required, the attentiveness of the occupant (particularly, the driver) is not lowered.

The effect of the refresh device 10 will be described.

(1) The control device 11 of the refresh device 10 causes the relaxation device 12 to execute a refresh operation that alleviates tension of an occupant, based on at least one information of traveling state information of a vehicle, information on a vehicle position PM and a road around the vehicle position PM, and information on a traffic control device around the vehicle.

According to this configuration, it is possible to give the refresh operation to the occupant based on an environmental change around the occupant during driving of the vehicle, instead of a change in a body motion (for example, heartbeat fluctuation) of the occupant (including a driver). Accordingly, it is possible to refresh the occupant at a proper time regardless of the change in the body motion of the occupant.

(2) The relaxation device 12 executes the refresh operation when the vehicle is present within the intersection area AC and the vehicle is in a stopped state.

According to this configuration, when the occupant may relax, the refresh operation may be given to the occupant. Since the occupant is subjected to the refresh operation in a relaxed state, the refresh effect is increased.

(3) The relaxation device 12 keeps the stop of the refresh operation when the vehicle is present within the intersection area AC and a vehicle speed is equal to or higher than an operation stop threshold.

According to this configuration, when an attentiveness is required, since the stop of the refresh operation is kept, the driver may keep the attentiveness.

(4) The relaxation device 12 executes the refresh operation when a road in front of the vehicle is straight and the distance of the straight road in front of the vehicle is equal to or longer than a reference distance.

According to this configuration, the refresh operation may be given to the occupant when the occupant may perform driving in a relaxed state. Since the occupant is subjected to the refresh operation in the relaxed state, the refresh effect is increased.

(5) The relaxation device 12 executes the refresh operation under a condition in which the road where the vehicle is traveling is a specific road.

According to this configuration, on a general road, even when the distance of the straight road is equal to or longer than the reference distance, the refresh operation is not executed. For example, during the traveling of the vehicle, the refresh operation is executed on a specific road where a frequency of entries of vehicles from left and right directions is low. This prevents an attentiveness from lowering due to an automatic activation of the refresh operation, on the straight road of the general road.

### Another Embodiment

The refresh device 10 is not limited to the example in the embodiment.

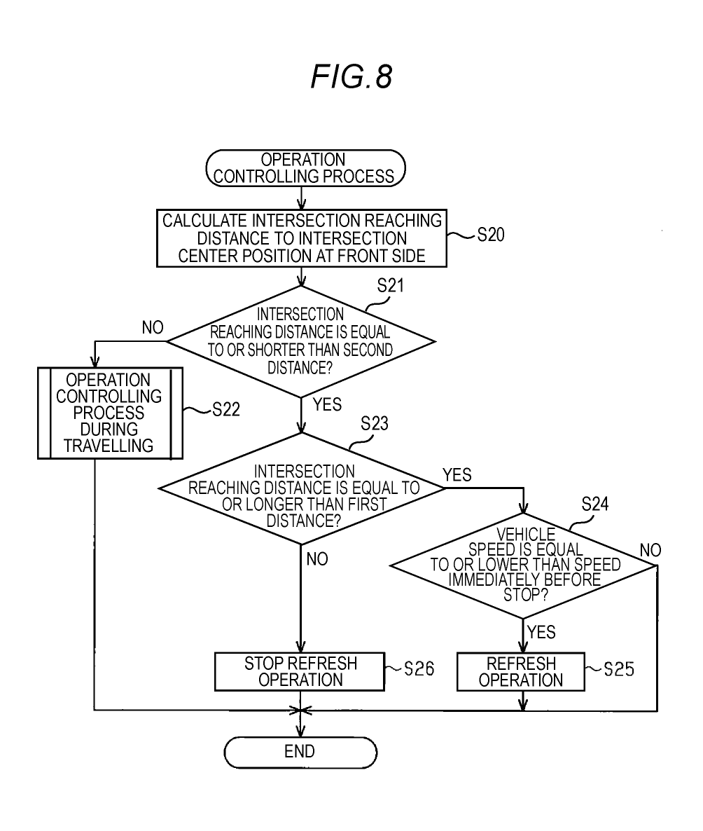

Another example of the “operation controlling process” will be described with reference to FIGS. 7 and 8. This example is different from the above embodiment, in the execution conditions of the “refresh operation” in the intersection area AC.

The control device 11 periodically executes an “operation controlling process.”

In step S20, the control device 11 calculates a distance from a vehicle position PM to an intersection center position PC at the front side (hereinafter, an “intersection reaching distance LX”). The control device 11 calculates the intersection reaching distance LX based on the vehicle position PM at the present point in time acquired from the navigation system 22, and the intersection center position PC. The intersection center position PC is a position set in advance at the intersection on a map. The intersection reaching distance LX is defined as a distance along the center line C in a width direction of a road. The intersection reaching distance LX is updated at the same cycle as that of the operation controlling process. The intersection reaching distance LX decreases as the vehicle approaches the intersection center position PC.

Thereafter, in step S21, the control device 11 determines whether the intersection reaching distance LX is equal to or shorter than a second distance LB. The second distance LB is longer than a first distance LA to be described below. The second distance LB may be set in advance based on, for example, the first distance LA, or calculated based on the first distance LA in a case where the first distance LA changes. When the intersection reaching distance LX is longer than the second distance LB (NO determination), in step S22, an “operation controlling process during travelling” is executed. The “operation controlling process during travelling” is the same as that in the example of the above embodiment.

When the intersection reaching distance LX is equal to or shorter than the second distance LB, the control device 11 determines whether the intersection reaching distance LX is equal to or longer than the first distance LA in step S23. The first distance LA is shorter than the second distance LB.

The first distance LA is a distance set based on a distance from the intersection center position PC to a stop line of the intersection. Otherwise, when another vehicle is stopped at the intersection while waiting for a light, the first distance LA is set based on a distance from the intersection center position PC to the rearmost position of the vehicle waiting for the light.

When the intersection reaching distance LX is equal to or longer than the first distance LA (YES determination), the control device 11 determines whether a vehicle speed is equal to or lower than a predetermined speed (hereinafter, “a speed immediately before stop”) in step S24. The speed immediately before stop indicates a speed when the vehicle speed is sufficiently reduced immediately before the vehicle is stopped such that the vehicle is capable of being stably stopped. When this condition (the condition in step S24) is satisfied (YES determination), in step S25, the control device 11 causes the relaxation device 12 to execute a refresh operation. When this condition (the condition in step S24) is not satisfied, this “operation controlling process” ends.

In step S23, when determining that the intersection reaching distance LX is not equal to or longer than the first distance LA (shorter than the first distance LA. NO determination), the control device 11 stops the refresh operation in step S26.

According to the above control, the refresh operation is executed when the vehicle approaches the intersection center position PC, and then the intersection reaching distance LX becomes equal to or shorter than the second distance LB, and the vehicle speed is sufficiently reduced (a speed equal to or lower than the speed immediately before stop). Meanwhile, when the vehicle speed is not sufficiently reduced (NO determination in step S24), the refresh operation is not executed. Then, when the vehicle approaches the intersection center position PC, in a case where the intersection reaching distance LX is shorter than the first distance LA, the refresh operation is stopped regardless of the magnitude of the vehicle speed. That is, near the center of the intersection, the refresh operation is stopped.

As described above, the refresh operation is automatically executed in a status where the necessity of attentiveness of an occupant is small. The refresh operation is automatically stopped in a status where the attentiveness of the occupant becomes necessary.

The refresh device 10 may have the following functions. The relaxation device 12 stops a refresh operation when the vehicle is present within the intersection area AC, and a traffic light in front of the vehicle indicates permission to proceed. For example, the control device 11 obtains traffic permission information indicating whether the traffic light corresponds to permission to proceed from a signal recognition device attached to the vehicle or a transmission device of the traffic light. Then, when acquiring information of permission to proceed, the control device 11 stops the refresh operation. According to this configuration, when the attentiveness becomes necessary as in a case where the vehicle is allowed to proceed and the traveling of the vehicle is started, the refresh operation is stopped. Accordingly, it is possible to call the occupant's (particularly, a driver's) attentiveness.

In the above embodiment, in the operation controlling process, when the vehicle speed is equal to or higher than the operation stop threshold (step S5), the refresh operation is stopped. Instead of this, or, in addition to this processing in step S5, the following processing may be executed. Based on information of “entry possible” output from the signal recognition device, the refresh operation is stopped. By such an operation, it is possible to call the occupant's (particularly, the driver's) attentiveness.

The refresh device 10 may have the following function. The control device 11 acquires traffic permission timing information transmitted by the traffic light. The traffic permission timing information is information indicating, for example, a timing at which a signal changes from prohibition to proceed (displayed in red) to permission to proceed (displayed in blue), and specifically, is time information indicating a time from the present point in time to a scheduled time for permission to proceed. Based on the traffic permission timing information, the control device 11 changes a mode of the refresh operation by controlling the relaxation device 12 at a point in time a predetermined time earlier before a scheduled time at which the traffic light indicates permission to proceed. According to this function, it is possible to call, in advance, the occupant's (for example, the driver's) attentiveness.

The refresh device 10 may have the following function. The control device 11 determines whether “a status where the necessity of attentiveness of an occupant is small” is satisfied, and controls a mode of the refresh operation based on this determination result. For example, the control device 11 executes the refresh operation only when “a status where the necessity of attentiveness of an occupant is small” is satisfied. Whether “a status where the necessity of attentiveness of an occupant is small” is satisfied may be determined according to whether, for example, a cruise control function is being operated. For example, when the cruise control function is being operated, it is determined that “a status where the necessity of attentiveness of an occupant is small” is satisfied.

The refresh device 10 may have the following function. When a predetermined time has elapsed from a point in time “a status where the necessity of attentiveness of an occupant is small” is satisfied, the control device 11 changes a mode of the refresh operation. For example, at a point in time after a predetermined time has elapsed from a point in time “a status where the necessity of attentiveness of an occupant is small” is satisfied, when it is determined that “a status where the necessity of attentiveness of an occupant is small” is to be continued afterwards, the control device 11 changes a mode of the refresh operation to an operation mode for promoting relaxation. At a point in time after a predetermined time has elapsed from a point in time “a status where the necessity of attentiveness of an occupant is small” is satisfied, when it is predicted that attentiveness becomes necessary afterwards, the control device 11 changes a mode of the refresh operation to an operation mode for promoting attentiveness. The determination as to whether “a status where the necessity of attentiveness of an occupant is small” continues after the present point in time, and whether attentiveness becomes necessary after the present point in time, may be performed based on, for example, road information on a route to a destination registered in the navigation system 22, congestion information in the corresponding route, or the like.

(1) A refresh device according to an aspect of this disclosure refreshes an occupant of a vehicle, and includes a control device, and a relaxation device controlled by the control device. The control device causes the relaxation device to execute a refresh operation that alleviates tension of the occupant based on at least one information of traveling state information of the vehicle, information on a vehicle position and a road around the vehicle position, and information on a traffic control device around the vehicle.

According to this configuration, it is possible to give the refresh operation to the occupant based on an environmental change around the occupant during driving of the vehicle, instead of a change in a body motion of the occupant (including the driver). Accordingly, it is possible to refresh the occupant at a proper time regardless of the change in the body motion of the occupant.

(2) In the refresh device, the relaxation device may execute the refresh operation when the vehicle is present within an intersection area and the vehicle is in a stopped state.

According to this configuration, when the occupant may relax, the refresh operation may be given to the occupant. Since the occupant is subjected to the refresh operation in a relaxed state, the refresh effect is increased.

(3) In the refresh device, the relaxation device may keep the stop of the refresh operation when the vehicle is present within the intersection area and a vehicle speed is equal to or higher than an operation stop threshold. According to this configuration, when an attentiveness is required, since the stop of the refresh operation is kept, the driver may keep the attentiveness.

(4) In the refresh device, the relaxation device may stop the refresh operation when the vehicle is present within the intersection area, and a traffic light in front of the vehicle indicates permission to proceed.

According to this configuration, when the attentiveness becomes necessary, since the refresh operation is stopped, it is possible to call the occupant's attentiveness.

(5) In the refresh device, the relaxation device may execute the refresh operation when a road in front of the vehicle is straight, and a distance of the straight road in front of the vehicle is equal to or longer than a reference distance.

According to this configuration, the refresh operation may be given to the occupant when the occupant may perform driving in a relaxed state. Since the occupant is subjected to the refresh operation in the relaxed state, the refresh effect is increased.

(6) In the refresh device, the relaxation device may execute the refresh operation under a condition in which a road where the vehicle is travelling is a specific road.

According to this configuration, on a general road, even when the distance of the straight road is equal to or longer than the reference distance, the refresh operation is not executed. Then, the refresh operation is executed only on the specific road, which prevents an attentiveness from lowering due to an automatic activation of the refresh operation, on the straight road of the general road.

According to the refresh device, it is possible to refresh the occupant at a proper time regardless of the change in the body motion of the occupant.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A refresh device that refreshes an occupant of a vehicle, the refresh device comprising:
a control device; and
a relaxation device controlled by the control device,
wherein the control device causes the relaxation device to execute a refresh operation that alleviates tension of the occupant based on at least one information of traveling state information of the vehicle, information on a vehicle position and a road around the vehicle position, and information on a traffic control device around the vehicle.

2. The refresh device according to claim 1,
wherein the relaxation device executes the refresh operation when the vehicle is present within an intersection area, and the vehicle is in a stopped state.

3. The refresh device according to claim 1,
wherein the relaxation device keeps stopping of the refresh operation when the vehicle is present within the intersection area, and a vehicle speed is equal to or higher than an operation stop threshold.

4. The refresh device according to claim 2,
wherein the relaxation device keeps stopping of the refresh operation when the vehicle is present within the intersection area, and a vehicle speed is equal to or higher than an operation stop threshold.

5. The refresh device according to claim 1,
wherein the relaxation device stops the refresh operation when the vehicle is present within the intersection area, and a traffic light in front of the vehicle indicates permission to proceed.

6. The refresh device according to claim 2,
wherein the relaxation device stops the refresh operation when the vehicle is present within the intersection area, and a traffic light in front of the vehicle indicates permission to proceed.

7. The refresh device according to claim 3,
wherein the relaxation device stops the refresh operation when the vehicle is present within the intersection area, and a traffic light in front of the vehicle indicates permission to proceed.

8. The refresh device according to claim 4,
wherein the relaxation device stops the refresh operation when the vehicle is present within the intersection area, and a traffic light in front of the vehicle indicates permission to proceed.

9. The refresh device according to claim 1,
wherein the relaxation device executes the refresh operation when a road in front of the vehicle is straight, and a distance of the straight road in front of the vehicle is equal to or longer than a reference distance.

10. The refresh device according to claim 2,
wherein the relaxation device executes the refresh operation when a road in front of the vehicle is straight, and a distance of the straight road in front of the vehicle is equal to or longer than a reference distance.

11. The refresh device according to claim 3,
wherein the relaxation device executes the refresh operation when a road in front of the vehicle is straight, and a distance of the straight road in front of the vehicle is equal to or longer than a reference distance.

12. The refresh device according to claim 4,
wherein the relaxation device executes the refresh operation when a road in front of the vehicle is straight, and a distance of the straight road in front of the vehicle is equal to or longer than a reference distance.

13. The refresh device according to claim 5,
wherein the relaxation device executes the refresh operation when a road in front of the vehicle is straight, and a distance of the straight road in front of the vehicle is equal to or longer than a reference distance.

14. The refresh device according to claim 6,
wherein the relaxation device executes the refresh operation when a road in front of the vehicle is straight, and a distance of the straight road in front of the vehicle is equal to or longer than a reference distance.

15. The refresh device according to claim 7,
wherein the relaxation device executes the refresh operation when a road in front of the vehicle is straight, and a distance of the straight road in front of the vehicle is equal to or longer than a reference distance.

16. The refresh device according to claim 8,
wherein the relaxation device executes the refresh operation when a road in front of the vehicle is straight, and a distance of the straight road in front of the vehicle is equal to or longer than a reference distance.

17. The refresh device according to claim 9,
wherein the relaxation device executes the refresh operation under a condition in which a road where the vehicle is travelling is a specific road.

18. The refresh device according to claim 10,
wherein the relaxation device executes the refresh operation under a condition in which a road where the vehicle is travelling is a specific road.

19. The refresh device according to claim 11,
wherein the relaxation device executes the refresh operation under a condition in which a road where the vehicle is travelling is a specific road.

20. The refresh device according to claim 12,
wherein the relaxation device executes the refresh operation under a condition in which a road where the vehicle is travelling is a specific road.

21. The refresh device according to claim 13,
wherein the relaxation device executes the refresh operation under a condition in which a road where the vehicle is travelling is a specific road.

22. The refresh device according to claim 14,
wherein the relaxation device executes the refresh operation under a condition in which a road where the vehicle is travelling is a specific road.

23. The refresh device according to claim 15,
wherein the relaxation device executes the refresh operation under a condition in which a road where the vehicle is travelling is a specific road.

24. The refresh device according to claim 16,
wherein the relaxation device executes the refresh operation under a condition in which a road where the vehicle is travelling is a specific road.
